(19) United States
(12) Patent Application Publication
(10) Pub. No.: US 2008/0144716 A1
(43) Pub. Date: Jun. 19, 2008

(54) Method For Motion Vector Determination

(76) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,845

(22) PCT Filed: Mar. 11, 2004
(86) PCT No.: PCT/IB04/50233

§ 371 Date: Sep. 9, 2005

(51) Int. Cl. H04B 1/66; H04N 11/02

(52) U.S. Cl. 375/240.16

(57) ABSTRACT

In a method for determining motion vectors from image data for blocks or objects of an image taken from an image sequence a block B(X) or object of pixels is divided (33) in two or more groups (Gₐ, G_{b}) within the block B(X) or object a motion vector (Dₐ, D_{b}) are assigned to the block (B(X)) and applied to the pixels of the respective groups (Gₐ, G_{b}) within the block.

The invention relates to a method for determining motion vectors from image data for blocks or objects of an image taken from an image sequence. The invention further relates to a display device comprising a determinator for determining motion vectors for blocks or objects of an image taken from an image sequence, and to a computer program product comprising software code portions for determining motion vectors for blocks or objects of an image taken from an image sequence.

Determination of motion vectors from image data is required for a broad range of image processing applications. In a video coding framework such as MPEG or H.261, motion vectors are represented by motion vectors that determine motion (or object displacement) from one image to another. Determination of motion vectors can for instance be used for motion-compensated predictive coding. Since one picture in an image is normally very similar to a displaced copy of its predecessors, encoding determined motion vector data together with information on the difference between the actual image and its prediction either in the pixel- or DCT-domain allows to vastly reduce the temporal redundancy in the coded signal.

Further examples for the estimation of motion vectors comprise methods to estimate the motion model for image segments (objects), where the components of the motion vectors then contain the parameters of the motion model.

State-of-the-art techniques to estimate or determine motion vectors from image data usually apply some kind of Block Matching Algorithm (BMA), where an image is decomposed in blocks of fixed or variable size. Quite as well, the image can be decomposed in its dominant objects instead of its blocks (object segmentation), so that the subsequent description equally well holds for objects instead of blocks. For each block of the current image, a similar block in the previous image is searched, where a similarity measure is applied to identify the previous block most similar to the current block. The motion vector associated to the block of the previous image, for which the largest similarity was determined, then represents the motion vector associated to the pixels of the current block. Note that, when calculating the similarity measure, not all pixels of the two blocks that are to be compared have to be evaluated. E.g., the blocks can be spatially sub-sampled, so that only each k-th pixel of both blocks is considered for the evaluation of the similarity measure.

In general block-matching motion estimators are used to calculate a displacement vector for every block of pixels in an image, usually by selecting that vector from a candidate vector set that minimizes a match criterion. That vector is then the motion vector for the relevant block of the image. Within the concept of the invention “motion” may be any type of displacement, encompassing e.g. real motion (e.g. one or more objects moving within a displayed image), but also zooming in or zooming out of an image (the image becoming larger or smaller) or camera movement, in which case the image as a whole moves within the frame of the camera. Motion vectors comprise, within the concept of the invention, any estimation of motion or displacement data for blocks or objects, resulting from any method in which, based on a number of images of which the data are known, one or more further images are constructed. Said motion vectors are estimated to predict the position or other parameters of blocks or objects within said further images. An example of such a method is for instance video format conversion, in which method, by use of e.g. picture interpolation and/or de-interlacing, from video data in one video format (format A, source format) video data in another video format (format B, target format) are derived. In such a method, vectors can be used to estimate for blocks or object based on the known data in the one known video format (the source format) the data for said blocks or objects in the another video format (the target format). It is to be noted that using picture interpolation new images are constructed from the known images (picture interpolation) but using de-interlacing the known images are not changed but the distribution of data over scan lines is changed. Using vector assigned to blocks in such a video conversion method simplifies calculation, and e.g. enables compression of data. A further example is so-called “disparity estimation” for stereoscopic video in which on the basis of two images representing two stereoscopic views the local depth is estimated. In such embodiments vectors can be attributed to blocks or objects, which vectors enable to predict on the basis of known images the position of other parameters for said blocks in further images, e.g. interpolated or de-interlaced images or slightly displaced images due to a 3D effect in an stereoscopic image pair.

Notwithstanding these further possible applications for this invention, the invention is in particular useful for “classical” motion vectors, i.e. for predicting motion vectors for blocks or objects based on a number of preceding images to construct a (or a series) of following images.

Although the use of block motion vectors is generally a useful strategy artifacts may appear, for instance around the boundary of objects or when an object overlays a subtitle.

Furthermore a critical parameter in a block-matching algorithm is the size of the block. This parameter both determines the resolution of the estimated vector field and the sensitivity of the estimator for noise and periodic structures in the image. As a consequence, the optimal block size is a compromise. On the one hand, small block sizes lead to noisy motion vectors and a high sensitivity for periodic structures, whereas, on the other hand, big blocks lead to a poor vector resolution. A poor vector resolution yields vector fields in which the object boundary can only be coarsely approximated, resulting in blocking artifacts in applications that use these motion vectors.

It is an object of the invention to provide for an improved method and device and computer program product of the type as described in the opening paragraph.

To this end the method in accordance with the invention is characterized in that for a block or object the pixels are divided in two or more groups in accordance with a comparison of a division criterion with the information of the pixels, and for each group within the block or object a motion vector is determined, and the respective motion vectors are assigned to the block and applied to the pixels of the respective groups within the block.

Within the concept of the invention the group or block is divided into two or more groups based on a comparison between the information in the pixels within the group and a division criterion. As a consequence the relation between the groups of pixels and the block, i.e. which pixels belong to which group within the block follows from the comparison, i.e. is not fixed as would be the case when e.g. a block is divided into a number of equal parts. The latter would simply mean that the block size is reduced, i.e. smaller blocks are used. Within the concept of the invention a block is divided into groups based on the comparison between the division criterion and the information of the pixels.

The method in accordance with the invention allows larger block sizes to be used, while yet achieving better vector resolution. It has also been shown in experiments that artifacts are reduced.

The separation criterion may be a simple criterion, independent of the information content of the pixels. An example of such a simple criterion is a fixed threshold intensity, e.g. dividing each block into two groups, the first one comprising the pixels having an luminance value below a certain percentage (e.g. 50%) of the maximum luminance value, the second one comprising the pixels having an luminance value above said threshold.

Preferably, however, the division criterion is based on the information content of the pixels within the block. Examples of such criterion are e.g. dividing the block into two groups, wherein the criterion is an average intensity, or a color point area around the average color point. Such a division criterion is preferred since it leads to better results, since it leads to the possibility to assign more than one vector in all regions, regardless of their brightness levels.

In preferred embodiments the blocks or objects are divided into four or less, preferably two groups. Although within the broadest concept of the invention a block or object may be divided into any number of groups, a small number of groups, four or less and preferably two, is preferred. In most circumstances the additional division into more than four groups and often even into more than two only leads to a marginal improvement, or even noisy vector estimates, while complicating the method.

In preferred embodiments the division criterion is an average luminance value for the pixels within the block. This has proven to be a useful and simple criterion. This may be the average luminance value, i.e. the quotient of the sum of all luminance values and the number of pixels, or the median luminance value, i.e. that luminance value for which 50% of the pixels has a luminance value higher than that value and for which 50% has a luminance values less than or equal to said luminance value.

In preferred embodiments a comparison is made, after estimating the motion vectors for the groups constituting the block, between the motion vectors and if the difference between motion vectors of a number of groups is less than a threshold value, an average motion vector is calculated and attributed to said number of groups. The division into groups provides for an improved method. However, if the block is divided into a number of group, while the block in fact comprises only one object (and thus only one motion vector is the appropriate one) splitting the block into two or more groups will lead to small differences between the calculated motion vectors. The calculation of a motion vector is usually an approximation and is done on a limited number of pixels, so there is an error margin. If the difference between calculated motion vectors are below a threshold (for instance the error margin in calculation of the motion vectors) it is likely that the difference is due to approximation or calculation inaccuracies. In such cases it is useful to assign to the relevant groups the same motion vector, and choose an average of the motion vectors found.

These and other aspects of the invention are apparent from and will be elucidated with reference to the embodiments described hereinafter.

In the drawings:

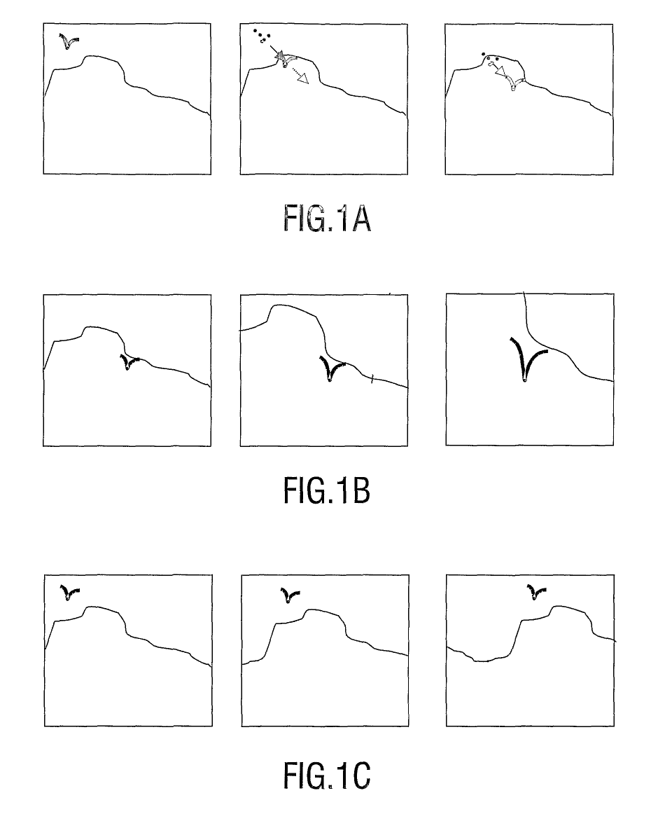

FIG. 1a to 1c illustrate different image sequences showing different types of motions or displacements.

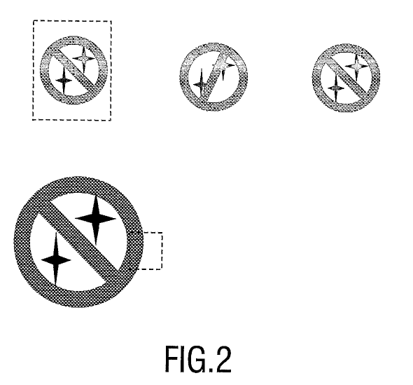

FIG. 2 illustrates a rotating wheel against a background.

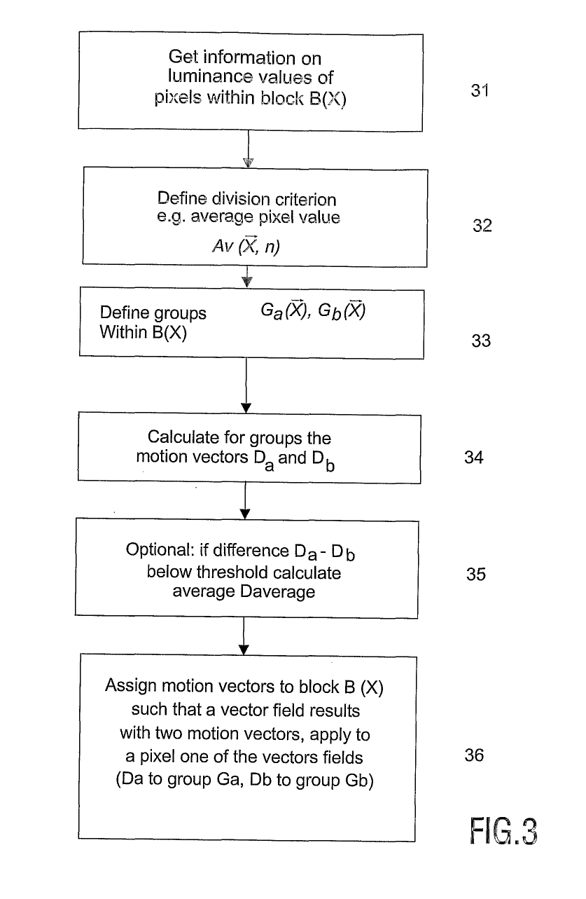

FIG. 3 illustrates by means of a flow diagram the different steps of an exemplary method in accordance with the invention.

The figures are not drawn to scale. Generally, identical components are denoted by the same reference numerals in the figures.

FIG. 1A to 1C illustrates very schematically different motions or displacements of or within an image.

In FIG. 1A a sequence of images is illustrated in which an object (a very simplified image of a bird) is moving against a background. From the first two images of the sequence a motion vector (the arrow in the middle image) can be established, which can be used to predict the position of the object (the bird) in the following image.

FIG. 1B illustrates an action in which the camera zooms in on the bird. Again, using the first two images of the sequence (or more in general a number of preceding images), to each block or object a motion vector (which could be more generally called a displacement vector) can be assigned to predict the position of the object or block on the following image within the sequence. To blocks or objects of the image motion vectors may be assigned, calculated on basis of the information in preceding images to make a prediction of the position of said blocks or objects in the following (or if the method is used for e.g. interpolating a number of “intermediate”) image(s) within the sequence.

FIG. 1C illustrates a camera movement, the camera moves with respect to the image. Again, using the first two images of the sequence (or more in general a number of preceding images), to each block or object a motion vector (which could be more generally called a displacement vector) can be assigned to predict the position of the object or block on the following image within the sequence, of course in this case this holds for those parts of the image that reoccur in the following shot, not for new parts. It is remarked that even for simple camera movements such as scanning the horizon, the vectors for blocks or objects may be different for different object, dependent on e.g. their position vis-à-vis the camera, e.g. whether the objects are in the foreground or the background of the image. Also objects may deform (because different parts of an object are positioned differently vis-à-vis the camera) as the camera position is changed.

Within the concept of the invention “motion vector” is thus to be broadly interpreted as denoting a set of parameters to predict any transformation of an object or block, such as for instance a simple translation T (for which a simple addition of a vector suffices, see e.g. FIG. 1A), a rotation R (for which a matrix multiplication with a rotational matrix suffices), enlargement (matrix multiplication, see for instance FIG. 1B) or deformation (more complex matrices will then be needed) or any combination of such translation, rotation, enlargement and/or deformation. The prediction is usable to predict the position of an object of block in succeeding images based on the information available in preceding images.

In general block-matching motion estimators (BMA) are used to calculate a motion vector for every block of pixels in an image, usually by selecting that vector from a candidate vector set that minimizes a match criterion. That vector is then the motion vector for the relevant block of the image.

U.S. Pat. No. 5,072,293 e.g. discloses such a BMA, where predictions from a 3D neighborhood are used as candidate vectors for motion vector estimation. The set of candidate motion vectors comprises both spatial (2D) and temporal (1D) predictions of motion vectors, the best of which is determined for each block recursively. The technique is recursive in that at least one candidate motion vector in the set of candidate motion vectors for a block in the current image n depends on already determined motion vectors of other blocks in the image n (spatial predictions) or in the preceding image n-1 (temporal predictions.

FIG. 2 illustrates a rotating wheel against a background of stars. The wheel rotates whereas the stars have a fixed position.

In a (block matching, or any other type of) motion estimator it is tried to match a shifted portion of a previous (or next, or both) image to a fixed portion of the present image. In our example used to elucidate the invention, the estimator uses e.g. the Summed Absolute Difference (SAD) as the matching criterion:

$$SAD ( \vec{C} , \vec{X} , n ) = {\sum }_{\vec{x} ∈ B ( \vec{X} )} \vert F ( \vec{x} - \vec{C} , n - 1 ) - F ( \vec{x} , n ) \vert , \qquad ( 1 )$$

where \vec{C} is the candidate vector under test, vector \vec{X} indicates the position of the block B(\vec{X}), F(\vec{x},n) is the luminance signal, and n the picture or field number. The motion vector that results at the output—one vector per block—is the candidate vector that gives the lowest SAD value. The quality of the above motion estimator is largely determined by the way the candidate vectors are generated. In this invention disclosure, we are indifferent concerning this choice. Good results (depending on the application) can be achieved with a full-search, a three-step search, a one-at-a-time search, or a 3-D Recursive Search block matcher. Also possible is a so-called hierarchical motion estimator method, in which method conventionally first for a relatively large block (e.g. 32×32 pixels) a motion vector is estimated, whereafter the large block is cut into smaller blocks (e.g. 4 of 16×16 pixels) and the motion vector of the large block is transferred to the next hierarchical level, i.e. the motion vector of the large block is used as a starting point for the calculation of the motion vectors for the smaller blocks. The method in accordance with the invention can be used for a hierarchical motion estimator method, there then two (or more dependent on the division criterion) motion vectors are transferred to the next hierarchical level.

A critical parameter in any such a block-matching (or any matching) algorithm is the size of the block. This parameter both determines the resolution of the estimated vector field and the sensitivity of the estimator for noise and periodic structures in the image. As a consequence, the optimal block size is a compromise. On the one hand, small block sizes lead to noisy motion vectors and a high sensitivity for periodic structures, whereas, on the other hand, big blocks lead to a poor vector resolution. A poor vector resolution yields vector fields in which the object boundary can only be coarsely approximated, resulting in blocking artifacts in applications that use these motion vectors.

If a relatively large block or object size is chosen, such as for instance schematically indicated by the dotted rectangle in FIG. 2, the resulting motion vector will be off target. If calculation of the motion vector (which may be a rotational matrix) is near the true rotation of the wheel the motion vector is wrong for the stars, if the motion vector is found to be near zero (correct for the stars) the predicted motion vector if off target for the wheel. Any average value is off target for both the wheel and the stars. By using a smaller block size, such as schematically indicated in the lower part of FIG. 2, for most of the figure the problem are reduced, however at the cost of a reduced accuracy for the predicted motion vector(s). Even so, even for a small block size, such as for instance shown by rectangle 21, the same problem occurs. The present invention aims to provide a way to resolve or at least reduce the problems.

To this end, the match criterion is modified, and based on that modified criterion, more than one vector per block are assigned.

The method in accordance with the invention is characterized in that for a block or object the pixels are divided in two or more groups in accordance with a comparison of a division criterion with the information of the pixels, and for each group within the block or object a motion vector is determined, and the respective motion vectors are assigned to the block and applied to the pixels of the respective groups within the block. The basic insight is that, if within a block or object there are groups of pixels for whom the best prediction for the motion vector differ, a division can be made between groups on the basis of the information of the pixels, by comparing the information of the pixels to a division criterion, whereafter for each of the groups a motion vector is determined, and the respective motion vectors are assigned to the pixels within each group.

To elucidate the invention, we shall describe an example motion estimator, according to our invention, in which each block is split into two groups of pixels, while the estimator assigns a motion vector to both groups, i.e. 2 vectors per block.

The average pixel value of the pixels in block B(\vec{X}) may be defined as follows:

$$Av ( \vec{X} , n ) = 1 / N {\sum }_{\vec{x} ∈ B ( \vec{X} )} F ( \vec{x} , n ) , \qquad ( 2 )$$

where N is the number of pixels in B(\vec{X}). B(\vec{X}) would in this example be e.g. the pixels within an object or within a rectangle of a size n×m, for instance with n and m between 4 and 32, for instance 16×16.

Now we define two groups, Gₐ(\vec{X}),G_{b}(\vec{X}), of pixels together forming block B(\vec{X}):

Gₐ(\vec{X})={x∈B(\vec{X})|F(\vec{x},n)>Av(\vec{X},n)} (3)

i.e. those pixels within block B(\vec{X}) with a luminance value larger than the average luminance value, and

G_{b}(\vec{X})={x∈B(\vec{X})|F(\vec{x},n)≦Az(\vec{X},n)} (4)

i.e. those pixels with an luminance value equal or smaller than the average luminance value. In the proposed estimator now for each group, Gₐ(\vec{X}), G_{b}(\vec{X}), motion vectors Dₐ and D_{b} are calculated such that Dₐ is the candidate vector that minimizes the SADₐ for the pixels in group Gₐ:

$${SAD}_{a} ( \vec{C} , \vec{X} , n ) = {\sum }_{\vec{x} ∈ {G}_{a} ( \vec{X} )} \vert F ( \vec{x} - \vec{C} , n - 1 ) - F ( \vec{x} , n ) \vert , \qquad ( 5 )$$

and D_{b} is the candidate vector that minimizes SAD_{b} for the pixels in group G_{b}:

$${SAD}_{b} ( \vec{C} , \vec{X} , n ) = {\sum }_{\vec{x} ∈ {G}_{b} ( \vec{X} )} \vert F ( \vec{x} - \vec{C} , n - 1 ) - F ( \vec{x} , n ) \vert , \qquad ( 6 )$$

Both motion vectors Dₐ and D_{b} are assigned to block B(\vec{X}), such that a vector field results with two motion vectors for every block in the image. More precisely, for pixels with a luminance value above the average luminance in the block they apply Dₐ and to the other pixels D_{b}. In the given example for instance the average luminance value is used as a division criterion. Even such a simple division into two groups based on the average luminance value will lead to the formation of two groups, one group mostly comprising the low intensity pixels, such as the stars, and another mostly comprising the pixels associated with the wheel, The two predicted motion vectors are then close to the correct value of the wheel and the stars, and assigned to the different groups will give a better result. A different division criterion would be the median luminance value, which would also lead to good results.

Using the median luminance value has the advantage that the groups always comprise 50% of the pixels thus a statistically relatively large number of pixels. It is throughout possible to divide the block into more groups, and they need not be of equal size. In this example for instance a division into three groups, one having a luminance value less smaller than 0.5 the average luminance value, one for pixels in between 0.5 and 1.5 the average luminance value and one for luminance value higher than 1.5 the average luminance value, may give better results under certain conditions.

FIG. 3 illustrates by means of a flow diagram the different steps of an exemplary method in accordance with the invention. In a first step the 31 information on luminance values of pixels within block B(X) is gotten. This is followed by a step 32 in which a division criterion is defined e.g. average pixel value or if the division criterion is already known a value for the division criterion e.g. the average luminance value is calculated. This step is followed by a step 33 in which groups within the block B(X) are defined, i.e. it is calculated which pixels belong to which group by comparing the information of the pixel to the division criterion, in the example for instance defining whether or not a pixel belongs to the one or the other group on the basis of the sign of the difference between the luminance value of the pixel and the average luminance value. This step is followed by a step 34 in which for each of the groups (in the example for the two groups) the motion vector is determined. For determination of the motion vector any known determination method may be used within the present invention. Good results (depending on the application) can be achieved with a full-search, a three-step search, a one-at-a-time search, or a 3-D Recursive Search block matcher. The step in which the motion vectors are determined is optionally followed by step 35 in which the difference between the motion vectors is compared to a threshold and if, the difference is less than a threshold an average motion vector is used for both groups. Finally in step 36 Assign motion vectors to block B(X) such that a vector field results with two motion vectors, apply to a pixel one of the vectors fields (Da to group Ga, Db to group Gb).

The invention relates also to a display device comprising a determinator for determining motion vectors for blocks or objects of an image taken from an image sequence, characterized in that the determinator comprises a divider to divide a block or object the pixels in two or more groups in accordance with a comparison of a division criterion with the information of the pixels, the determinator determines subsequently for each group within the block or object a motion vector, and the determinator comprises an assignator to assign the respective motion vectors to the block for application to the pixels of the respective groups within the block.

The invention further relates to a computer program product comprising software code portions for determining motion vectors for blocks or objects of an image taken from an image sequence in accordance with the method of the invention in its broadest sense, as well as in any of the embodiments, in particular the preferred embodiment.

Within the concept of the invention “determinator”, “divider”, “assignator” is to be broadly understood and to comprise e.g. any piece of hard-ware (such a determinator, divider, assignator), any circuit or sub-circuit designed for performing a determination, division, assignment as described as well as any piece of soft-ware (computer program or sub program or set of computer programs, or program code(s)) designed or programmed to perform a determination, division, assignment as well as any combination of pieces of hardware and software acting as such, alone or in combination, without being restricted to the below given exemplary embodiments.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The present invention has been described in terms of specific embodiments, which are illustrative of the invention and not to be construed as limiting. The invention may be implemented in hardware, firmware or software, or in a combination of them. Other embodiments are within the scope of the following claims.

1. A method for determining motion vectors from image data for blocks or objects of an image taken from an image sequence, characterized in that for a block B(X) or object the pixels are divided (33) in two or more groups (Gₐ, G_{b}) in accordance with a comparison of a division criterion (Av(X,n)) with the information F(x,n) of the pixels, and for each group (Gₐ, G_{b}) within the block B(X) or object a motion vector (Dₐ, D_{b}) is determined (34), and the respective motion vectors (Dₐ, D_{b}) are assigned to the block (B(X)) and applied to the pixels of the respective groups (Gₐ, G_{b}) within the block.

2. A method as claimed in claim 1, characterized in that the number of groups per block is equal to or less than four.

3. A method as claimed in claim 1, characterized in that the number of groups per block is two.

4. A method as claimed in claim 1, characterized in that the division criterion (Av(X,n)) is determined based on the information content (F(x,n) of the pixels within the block B(X).

5. A method as claimed in claim 4, characterized in that the division criterion is the average luminance value of the pixels within the group.

6. A method as claimed in claim 4, characterized in that the division criterion is the median luminance value of the pixels within the group.

7. A method as claimed in claim 1, characterized in that the difference between motion vectors determined for different groups is compared to a threshold value, and, if the difference is less than the threshold value, the respective motion vectors are replaced by a combination of said motion vectors.

8. A display device comprising a determinator for determining motion vectors for blocks or objects of an image taken from an image sequence, characterized in that the determinator comprises a divider to divide a block or object the pixels in two or more groups in accordance with a comparison of a division criterion with the information of the pixels, the determinator determines subsequently for each group within the block or object a motion vector, and the determinator comprises an assignator to assign the respective motion vectors to the block for application to the pixels of the respective groups within the block.

9. A computer program product directly loadable into the internal memory of a digital computer, comprising software code portions for performing the steps of claim 1 when said product is run on a computer.
